(19) United States
(12) Patent Application Publication
(10) Pub. No.: US 2003/0190849 A1
(43) Pub. Date: Oct. 9, 2003

(54) Line termination incorporating compensation for device and package parasitics

(76) Inventors: Alexander Roger Deas, Edinburgh (GB); Igor Anatolievich Abrosimov, St. Petersburg (RU)

Correspondence Address: DEAS, Alexander, Roger, Office 501, 58, Moika Embankment, St. Petersburg, 190000, RU

(21) Appl. No.: 10/383,727

(22) Filed: Mar. 10, 2003

(30) Foreign Application Priority Data
Apr. 5, 2002 (GB) 0208014.1

(51) Int. Cl. H01R 9/22

(52) U.S. Cl. 439/894

(57) ABSTRACT

A distributed terminator for terminating a transmission line linking a plurality of integrated circuits. The terminator comprises a plurality of resistors and a capacitor that is usually an ESD structure. The values of the resistors are such that the reflection co-efficient of the combined termination is lower across the bandwidth of the signal being transmitted than a reflection coefficient with a termination using resistors in the same topology where the effective value of the resistors is equal to the line impedance.

### BACKGROUND OF THE INVENTION

1. Technical Field

The present invention relates to the communication of signals, in particular, to the transmission and reception of digital signals, where the signals are at such a frequency that they are distorted by the non-linear behaviour of the package parasitics and ESD (Electrostatic Discharge) protection structures within the receiver.

The present invention is particularly applicable to interfaces between integrated circuits and for high speed communications, such as currently addressed by Asynchronous Transfer Mode (ATM), Gigabit Ethernet, 3GIO, RapidIO, Hyperchannel and Fibre Transmission Channels, and makes possible yet higher data rates for a particular bandwidth of the transmission medium.

2. Background of the Invention

It has been common practice for many decades to terminate lines used to convey high frequency signals. The termination impedance matches the impedance of the transmission medium, such that when the signal is properly terminated, none of the energy is reflected back into the medium.

Where lines carry continuous signals, such as radio signals, resistors, capacitors and inductors, simple inductors or ballun transformers may be used to terminate a line. Where perfect termination is not possible, the physical properties of the medium may be modified as it approaches the termination, such as by changing the width of pcb tracks or introducing stubs. In the field of digital communication, the termination options available are much more restrictive because the signals have a very wide bandwidth.

Hitherto, most high speed digital communications occurred within the bandwidth of the communication channel, or within a small multiple of that, such as 2GHz data being sent in a 1GHz channel. In this case, simple termination schemes are effective, such as described in U.S. Pat. No. 5,663,661, and used commonly in SCSI buses, IEEE 488 and in ECL circuit designs dating back the early 1960s. At speeds above the bandwidth of the channel, these are ineffective because a large part of the channel non-linearity occurs as a result of the package parasitics and the ESD structure of the receiver.

Continuous scaling of integrated circuits has enabled a rapid increase in IC operating frequencies. Parasitic capacitance of ESD protection circuits slows signals down and has made ESD circuits a major bottleneck for high-speed operation. In narrow-band designs, this capacitance can be resonated out with a package/bondwire inductance, and thereby circumvented. However, this approach is not applicable to broadband designs, and therefore the parasitic capacitance of ESD circuits continues to be a problem in conventional broadband designs.

In some cases, the location of terminating components have migrated to the integrated circuit, and this is effective where the data rates are less than four times the bandwidth of the channel.

The present invention is concerned with sending and receiving data in a channel at higher multiples of the channel bandwidth, such as 6:1 or 10:1. For example, sending 40 Gbps across a channel with 2 GHz bandwidth, or 13 Gbps across a channel with 1 GHz bandwidth. In these cases there is a complex interaction between the package and the input ESD. With termination methods known in the art, this leads to insufficient line termination.

At the transmitter, it is common practice to match the driver into the load, such as in U.S. Pat. Nos. 4,719,369, 5,955,894, 6,222,389, 6,060,907 and 6,118,310. Numerous attempts have been made to match the receiver impedance to the line, such as in U.S. Pat. Nos. 5,602,494, 5,604,450, 6,323,673 and 5,578,939, and particularly in U.S. Pat. No. 6,026,456 but all these schemes ignore the effect of the ESD structure and its interaction with the package parasitics, which offer a radically different impedance to the signal than the traces on the pcb. Thus, the signal can travel down a transmission line which is 50 Ohms and be terminated on the die at, for example 50 ohms. However, a highly non-linear combination of inductors, capacitors and resistors between the die and the transmission line will cause a large portion of the signal to be reflected.

Techniques such as described in U.S. Pat. No. 6,157,688 attempt to reduce the reflections of system with multiple drops by distributing the terminating components, but again idealise the package parasitics and ESD structure, such that none of this reactive impedance is considered. The result is a very unsatisfactory impedance match at very high frequencies.

In U.S. Pat. No. 5,635,761 thin film conductor technology is used to form precise resistors within a package. However, the function of these is simply to terminate the line impedance, and there is no attempt to manage the complex reactance of either the package or the input impedance of the die itself.

In U.S. Pat. No. 5,708,400, power supplies are terminated using reactive components, in particular, capacitors in series with resistors used to terminate lines at very high frequency, but this technique uses the reactive elements simply to avoid a DC power loss and is little different from simply using decoupling capacitors as has been the standard practice for many decades.

In U.S. Pat. No. 5,982,191, a distributed terminator is used, but again this is only resistive and its purpose is purely to match the line impedance. This is also true in U.S. Pat. Nos. 5,808,576, 5,990,701, 6,232,792.

In U.S. Pat. No. 6,127,840 an attempt is made to clamp the line, but this results in a larger reflection back into the line and hence increases the intersymbol delay of subsequent data bits.

U.S. Pat. No. 4,267,538 described a termination for a microwave pin diode switch to eliminate the necessity for adaptive gain control and to minimise signal degradation caused by intersymbol interference. This invention applies to a narrow band device, where a quarter wave transmission line and simple terminating resistor is used. Techniques such as this, using stubs, work well for RF (radio frequency) systems where the signal occupies a narrow spectral band, but exacerbate the problems in a digital system where the signals are wide band.

Summarising, in the prior art, attention is given to terminating lines and more recently, trying to equalise the package parasitics using filters. Package parastics are reduced in packages designed for high speed components. For example, Amkor offer packages which have sufficiently low parasitics to enable communication at 40 GHz.

However at frequencies of 3 GHz and higher, the problem still exists where the effect of the ESD in the integrated circuit itself is so severe to distort the signal to a far greater extent than the combined effect of skin effects and the package. That is, the biggest problem is almost totally ignored in the prior art. The parasitic components, and particularly the parasitic capacitance in the ESD structure, causes a large reduction in the amplitude of the signal received, as shown in FIG. 4 for an example network with 3 pF drive parasitics and an ESD structure with 3 pF input capacitance, running through a commonly available integrated circuit package. This reduction in amplitude is due to a shunt impedance which causes large reflections back into the transmission line at high frequencies. The present invention seeks to minimise these reflections and improve the overall signal to noise ratio at the receiver.

### BRIEF SUMMARY OF THE INVENTION

Thus, it is an object of the present invention to minimise the reflections back into the transmission line at high frequencies and improve the overall signal to noise ratio at the receiver.

In other words, it is an object of the current invention to improve the efficiency of line termination where the data communicated through the line is at a frequency above the pass band of the filter formed by the device package parasitics and device capacitance.

It is a further object of the present invention to enable effective ESD structures to be incorporated in systems which send data at a large multiple of the channel bandwidth, for example in sending 6 Gbps through a 1 GHz BW channel, or 40 Gbs through a 2 GHz BW channel.

The above objects are achieved by providing a distributed terminator for terminating a transmission line having its end linked to an integrated circuit, the terminator comprising a parallel-connected resistor means connected in parallel to said integrated circuit, wherein the terminator further comprises a series resistor means connected in series to the transmission line and said integrated circuit.

The overall resistance value of the parallel-connected resistor means and series resistor means shall be substantially the impedance of the transmission line. However, the effect of the invention will still exist if the overall resistance value of the resistors differs from the transmission line impedance by 20% or less.

In actual practice, the transmission line is linked to the integrated circuit via a driver or receiver incorporated therein. The distribution of the overall resistance between the parallel-connected resistor means and series resistor means depends mostly on the capacitance of the driver or receiver. It further depends on the signalling frequency and impedance of the transmission line. Different combinations of these parameters can result in resistance value of the parallel-connected resistor means that is 5-95% less than the impedance of the transmission line.

A finished integrated circuit has a package. The series resistor means can be arranged outside the package or form a part of the package. The parallel-connected resistor means can be arranged within the integrated circuit package or within the integrated circuit.

Preferably, the parallel-connected resistor means includes a plurality of resistors connected in parallel to said integrated circuit, and the series resistor means includes a plurality of resistors connected in series to the transmission line and said integrated circuit. In this case, the resistance of the parallel-connected resistor means will be the overall resistance of said plurality of resistors connected in parallel, and the resistance of the series resistor means will be the overall resistance of said plurality of resistors connected in series. It shall be appreciated that at least some of the resistors connected in parallel to said integrated circuit can also be connected in series to each other. Similarly, at least some of the resistors connected in series to the transmission line and said integrated circuit can also be connected in parallel to each other.

Any integrated circuit package has a certain resistance, as well as capacitance and inductance. Thus, said plurality of resistors connecred in series can include package components as resistors.

According to a preferable embodiment of the present invention, the parallel-connected resistor means is connected to a terminating voltage within the integrated circuit.

The terminator can further include an inductor connected in series at least to one resistor of the parallel-connected resistor means.

Preferably, the resistance value of said parallel-connected resistor means is determined with consideration for the capacitance of the package.

The above objects are further achieved by providing a data communication apparatus comprising a transmission line connected to an integrated circuit via a driver incorporated therein, where the transmission line is terminated by a terminator comprising a parallel-connected resistor means connected in parallel to said driver and a series resistor means connected in series to the transmission line and said driver.

The above objects are further achieved by providing a data communication apparatus comprising a transmission line connected to an integrated circuit via a receiver incorporated therein, where the transmission line is terminated by a terminator comprising a parallel-connected resistor means connected in parallel to said receiver and a series resistor means connected in series to the transmission line and said receiver.

The above objects are further achieved by providing a data communication system comprising a first integrated circuit, a second integrated circuit and a transmission line linking the first integrated circuit to the second integrated circuit, wherein the transmission line is terminated by a distributed termination as described above.

The above objects are further achieved by providing a method of terminating a transmission line having its end connected to a receiver or driver incorporated in an integrated circuit, the method including the following steps:

determining the impedance of the transmission line;

determining the capacitance of said receiver or driver;

selecting desired frequency interval;

calculating the value of a parallel-connected resistor means and a series resistor means as a function of the impedance of the transmission line, capacitance of said receiver or driver and the selected frequency interval;

providing parallel-connected resistor means and series resistor means having the calculated values;

connecting the parallel-connected resistor means in parallel to said integrated circuit, and connecting the series resistor means in series to the transmission line and said integrated circuit.

Resistance values of the termination components are calculated to maximise signal to noise ratio, for example using MathCad optimisation.

All the calculations shall be made with consideration for capacitance values of inherent capacitance of the integrated circuit, its ESD (electrostatic discharge) protectioin circuit parasitic capacitance, and capacitive components of the package.

According to the invention, the values of the resistors are such that the reflection co-efficient of the combined termination is lower across the bandwidth of the signal being transmitted than a reflection coefficient with a termination using a single resistor having a resistance value equal to the line impedance. The capacitor which shall be taken into account when selecting appropriate termination can be either in a receiver or driver, incorporated into at least one integrated circuit and, as well as the ESD (electrostatic discharge) protection circuit parasitic capacitance. The value of the parallel resistor arranged within the integrated circuit is calculated then with the account of the input capacitance of the receiver or, its inherent capacitance, or the capacitor arranged within the integrated circuit. Similarly, the capacitor can be the output capacitance of a driver incorporated into at least one of the integrated circuits.

The present invention is particularly applicable for receivers and drivers incorporating an electrostatic discharge protections structures, and hence, the capacitance of the electrostatic discharge structure is inserted as the receiver or driver capacitance when making the calculations.

Preferably, the input capacitance of the receiver or the output capacitance of the driver is added to the capacitance of the electrostatic discharge structure when making the calculations.

The present invention distributes the termination of the line between terminating components within the integrated circuit or integrated circuit package to compensate for the characteristics of the ESD structure of the receiver or for the capacitance of the driver.

The device parasitic capacitance can present an impedance of ⅛^{th} of that of the transmission line, or even less, at high frequencies. This means that the signal is not only reflected back into the line, but the frequency dependent attenuation of the signal caused by ESD or driver structures and driver capacitance results in very little signal to sample. In extreme cases, the interaction of the ESD or driver capacitance and line inductance can cause resonance within the pass band. Hitherto, there has been no viable solutions for this problem except to reduce the amount of protection available from the ESD structures.

The present invention solves this problem sufficiently to enable conventional ESD structures to be used by developing a method for equalisation with consideration for the ESD structure and its interaction with other parasitics.

### BRIEF DESCRIPTION OF THE SEVERAL VIEWS OF THE DRAWING

A detailed description of the present invention will now be given, without loss of generality, and with reference to the following figures:

FIG. 1a shows a typical prior art termination scheme for a receiver.

FIG. 1b shows a simplified general termination scheme according to the invention.

FIG. 2 shows the dependence of the impedance of the transmission line on the signalling frequency for prior art termination and the present invention.

FIG. 3 is a circuit diagram of an embodiment of the present invention.

FIG. 4 shows the phase—frequency response of the circuit in FIG. 3 with typical values.

FIG. 5 shows the signal to noise ratio in the channel against frequency for the embodiment shown in FIG. 3. The dotted line is the signal and noise on the same frequency as a reflection, and the solid line is the ratio of the maximum noise over the whole frequency range to the signal on that frequency.

FIG. 6 shows the noise against frequency for the compensated channel according to FIG. 3 with component values optimised. The scale is in volts, so the noise varies from 11.1 mV to 10.8 mV showing the effective termination over the frequency range.

FIG. 7 shows the reflection coefficient against frequency for signals reflected from the receiver (top solid trace), from the driver (dotted trace), and the double reflection (bottom dashed trace).

FIG. 8 shows the input voltage against frequency as seen by the receiver, where the signal is running through the optimised channel.

### DETAILED DESCRIPTION OF THE INVENTION

Specific features and advantages of the present invention will become apparent from a detailed description of the present invention as compared to the prior art.

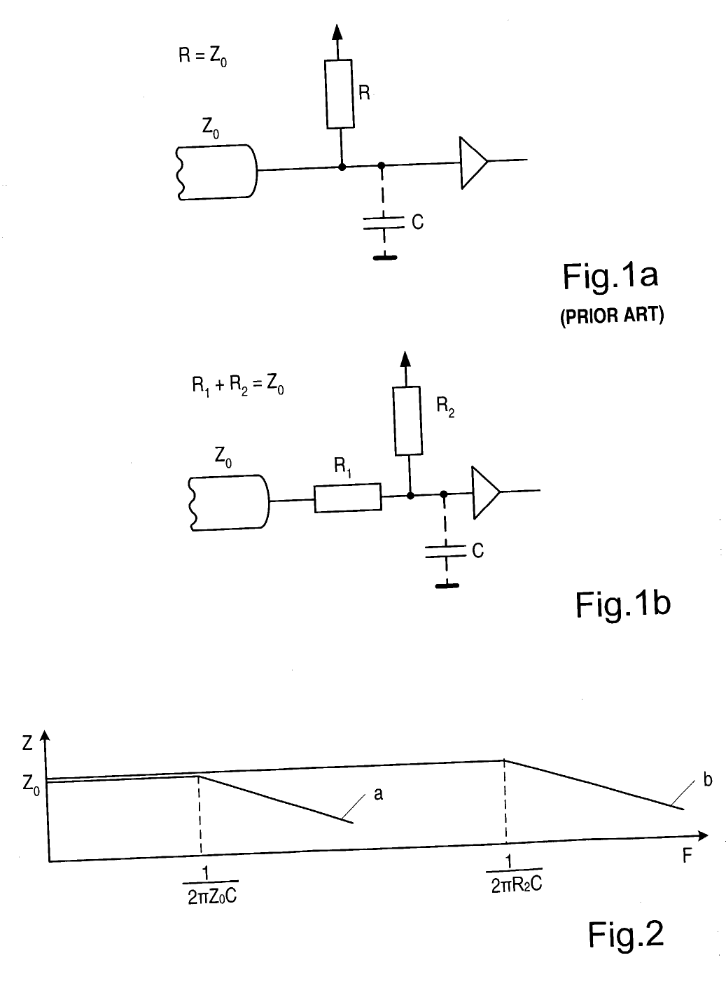

In FIG. 1a, a typical prior art termination circuit is shown schematically, in which a transmission line having impedance Zo and connected to a receiver having a parasitic capacitance C is terminated by a parallel-connected resistor R matching the impedance Z₀ of the transmission line. The behaviour of the prior art circuits is illustrated by curve “a” in FIG. 2, which shows a drastic decrease of the module of characteristic impedance Z at high frequencies, as defined by the following formula:

$$\vert {Z}_{in} \vert = \frac{R}{√ 1 + {( 2 π {F}_{max} RC )}^{2}} ∼ \frac{1}{2 π {F}_{max} RC}$$

From this formula, the turning point (seen in FIG. 2) of curve “a” where the characteristic impedance starts to decrease can roughly be estimated as:

$${F}_{decr} = \frac{1}{2 π {Z}_{0} C}$$

The general inventive concept of the present invention is to create a termination circuit in which this unwanted decrease is shifted towards much higher frequencies, and thus, to enable reliable operation of transmission circuits in the desired bandwidth.

FIG. 1a shows a simplified diagram of a termination circuit according to the invention for terminating a transmission line having the same impedance Zₒ and connected to a similar receiver circuit having parasitic capacitance C. The termination circuit also comprises a terminating resistor connected in parallel to the receiver. However, the resistance value of this resistor denoted as R₂ is below the impedance Zₒ of the transmission line. The termination circuit further comprises a series resistor R₁. Thus, line termination is distributed between two terminating components. Resistors R₁ and R₂ have values selected so that their overall resistance or sum of R₁+R₂ approximates the impedance of the transmission line. However, the effect of the invention will still exist if the overall resistance value of the resistors differs from the transmission line impedance by 20% or less.

The distribution of the overall resistance between the resistors R₁ and R₂ depends mostly on the values of signalling frequency, capacitance C, and impedance of the transmission line. Different combinations of these parameters can result in resistance value of resistor R₂ that is 5-95% less than the impedance of the transmission line. At higher frequencies, to avoid decrease of the transmission line characteristic impedance, as defined by the above equations, the value of resistor R₂ must be significantly lower than Zₒ. The dependence of the characteristic impedance of the transmission line for this arrangement is shown by curve “b” in FIG. 2.

In this case,

$${R}_{2} = \frac{1}{2 π {F}_{max} C} ,$$

so that the higher the frequency is, the lower shall be R₂ for providing the desired effect. As a result, much higher values of signalling frequencies can be used without deteriorating the transmission channel capabilities.

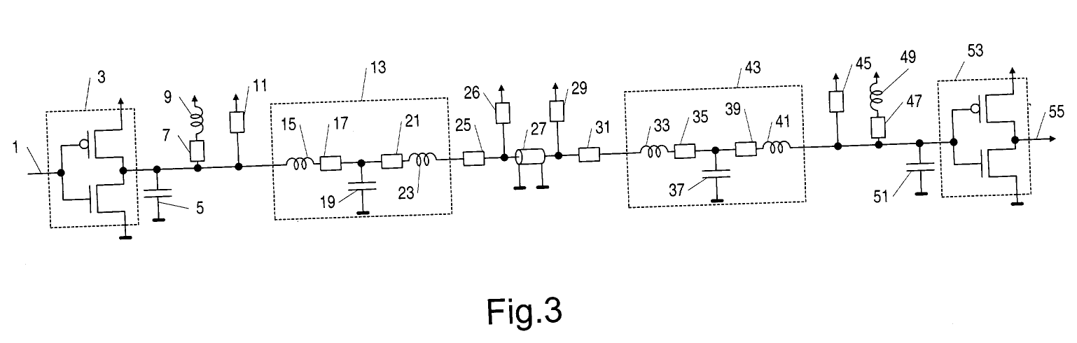

According to another example embodiment shown in FIG. 3, the terminator includes a plurality of resistors connected in parallel and a plurality of resistors connected in series. In this case, the overall resistance of said plurality of resistors connected in parallel will be R₂, and the overall resistance of said plurality of resistors connected in series will be R₁.

As shown in FIG. 3, a termination is applied to transmission line 27 linking two integrated circuits, one integrated circuit having a driver 3, and another integrated circuit having a receiver 53 incorporated therein. Each of the integrated circuits has a package 13 and 43 presented schematically in FIG. 3 as resistive, capacitive and inductive components.

The transmission line has known characteristics, particularly, characteristic impedance Z and estimated noise level in the transmission line Et. The estimated noise level in the integrated circuit, in particular, in the receiver 53, is Ec. The driver 3 has an ESD structure acting as parasitic capacitance Co 5. The receiver 53 has an ESD structure acting as parasitic capacitance Ci 51.

The terminator comprises a plurality of distributed termination components including a resistor Ruo 11 connected in parallel to ESD capacitor 5 Co. Further, according to the present example embodiment, the termination components include an inductor Luo 9 with Q defined by the process and by resistance Rlo 7, operating in combination with capacitor 5 Co, the package parasitics 13 which comprise resistors Rp/2 17 and 21, parasitic capacitance Cp 19, and lead inductances Lp/2 15 and 21, and external terminating network comprising resistors Rso 25 and Rxo 26.

The receiver has similar termination as the driver, but the values of components are generally different. This termination comprises a terminating network external to the device comprising resistors Rsi 31, Rxi 29, package parasitics 43 which are normally the same as for the driver package 33, 35, 37, 39, 41, terminating components internal to the package, including resistor Rui 45, inductance Lui 49 and resistor Rui 47, which operate in conjunction with the device ESD capacitance Ci 51 and parasitic input capacitance from the receiver 53.

An input signal 1 is driven into the transmission line 27 by the driver 3 and is outputted from the receiver 53 as an output signal 55. The line is terminated with the above terminating components, so that reflections back to the line are minimized.

Appendix A contains equations that are referred to in the text for the purposes of a clear description of how the component values required to implement the present invention may be calculated.

Conventionally, calculating the values of terminating components, where the device parasitics Co and Ci are ignored, is a straight forward matter that can be accomplished by experienced engineers using just mental arithmetic. This is due largely to the fact that, if Co and Ci are ignored, the effect of the device parasitics can be simplified. Engineers routinely ignore even the package parasitics to derive the value of terminating resistors.

According to the present invention, when Co and Ci are included into considerations, determining the values of all the terminating components is no longer a matter of mental arithmetic but requires the impedance of the network to be considered more carefully.

A method by which the values of the components used in FIG. 3 can be calculated, will now be described in detail.

On the first step, the values of Rp (in Ohms), Cp (in nF), Lp (in nH) are measured for the package to be used. For example, for silicon device mounted using solder ball flip chip technology Rp is 30 mOhms, Cp is 0.2 pF and Lp is 0.4 nH. The frequencies of interest are then selected to cover the signalling band, for example 0.4 GHz, 1 GHz, 2 GHz and 3.35 GHz. The output capacitance of the driver can be determined by extracting a HSPICE model from the silicon, and will be typically 3 pF on the driver, and 3 pF for the ESD structure of the receiver. Initial values may be given to the other components, such as:

Rp:=30·10⁻³ Cp:=0.2·10⁻³ Lp:=0.4 F1:=O.4 F2:=1 F3:=2 F4=3.25

Co:=3·10⁻Ci:=3·10⁻³ Ec:=0.005 Et:=0.002 Z:=54 I:=0.05

Luo:=1 Rlo:=5 Ruo:=30 Rso:=1 Rxo:=200 Lui:=1 Rli:=5 Rui:=20 Rsi:=25 Rxi:=110

The package parasitics (43: 33, 35, 39, 41, 37, and 13: 15,17, 19, 21, 23) is in many cases simply the bonding wire. It is possible to bond directly from the die to a resistor (25, 31) located within the package, which then provides a controlled impedance into the circuit board. In this case, the termination resistors 11 and 45 can be on the silicon chip, for example using an NMOS transistor or a polysilicon resistor, but in all cases, the capacitance (5 or 51), is on the silicon because it is a parasitic of either the driver or the ESD structure. The value of the termination resistors in each case according to the present invention differs significantly from the classical termination schemes which use the resistors to match the line impedance, so that the resistor values are generally equal to the line impedance, or half the line impedance. On the contrary, the present approach provides distributed termination wherein the values of termination components are selected aiming not only to match the impedance of the transmission line, but to maximise Signal-to-Noise ratio, which is of primary importance in high frequency signalling to make possible higher data rates at limited bandwidth of transmission media.

The next step is to determine the impedance of the transmission line as it is seen both at the driver, Zo, and at the receiver, Zi.

The output impedance Zo seen by the driver, including its own capacitance, is derived from the combination of the component impedances, as shown in Equation 1 in Appendix A for the example embodiment. The following parameters are used for the determination: initial values of the components of the transmission system, including values of resistors, Rp, capacitors Co, Cp, Ci, inductance Lp, estimated noise levels Et, and Ec, as defined above, the selected frequencies F1, F2, F3, F4, covering the signaling band, the value of the current at the driver, I, and initial impedance value Z. The output impedance Zo is calculated from electrical network analysis, which is an elementary subject taught sufficiently by first year university courses in Electronic Engineering that any competent electronic engineer should be able to derive this equation for any variation of termination and parasitic topology.

The impedance seen by the receiver, Zi, can be derived similarly as given by Equation 2 in Appendix A.

The next step is to calculate the signal to noise ratio of the channel (SNR), given reflections and channel noise. To do this, it is necessary to determine the amplitude of the signal received by the receiver.

The voltage received by the receiver at any given frequency can be calculated easily, such as shown in the Attachment A using Equations 3 for V1, V2, V3 and V4 to feed into the equation for Vi all as given in Appendix A for the example embodiment.

The noise seen at the receiver is a product of the reflections within the channel and the voltage noise. This can be calculated as shown in Equation 4 in Appendix A. It should be noted that the noise includes the reflections within the channel as a result of inefficient termination.

From these foregoing equations, the signal to noise ratio (SNR) can be defined as a function of the values of the components in the network, as shown in Equation 5 for the example embodiment.

Given these equations, and that the value of all components must be positive, the equations can be optimised by a variety of standard models which are widely available, such as in MathCAD Professional 2000, to yield the component values and can be performed by a specialist in the art. The specification of the optimisation expression in MathCAD is shown in Equation 6 along with the results for the example embodiment. The optimisation is performed to maximise the Signal-to-Noise Ratio and thus, to achieve the reliable transmission parameters at high frequencies for integrated circuits comprising ESD protection circuits. This advantage is of particular importance in various applications, such as programmable logic devices, such as macrocells, chip-to-chip communications, and others.

As seen from the results of optimisation as given in Equation 6, for the initial SNR being 0.16, the SNR achieved using the inventive approach of the present application has become 5.62. This gives a significant improvement to the signalling quality of the communication system.

Note that in this case, the pole created by the addition of the terminating inductor and series resistor (7, 9, 47 and 49 in FIG. 1) is not required, but is included here to enable the detailed method of evaluation of the circuit to be applied as broadly as possible. However, in some applications these inductive components- are required.

It should be noted that the value of the terminating components at each end is different.

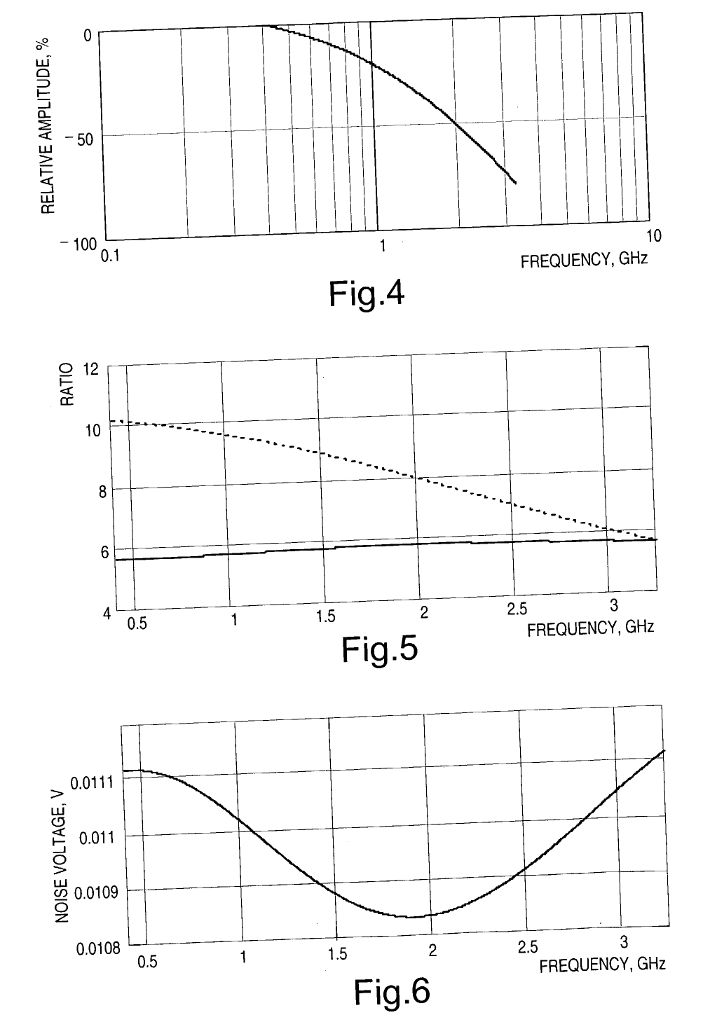

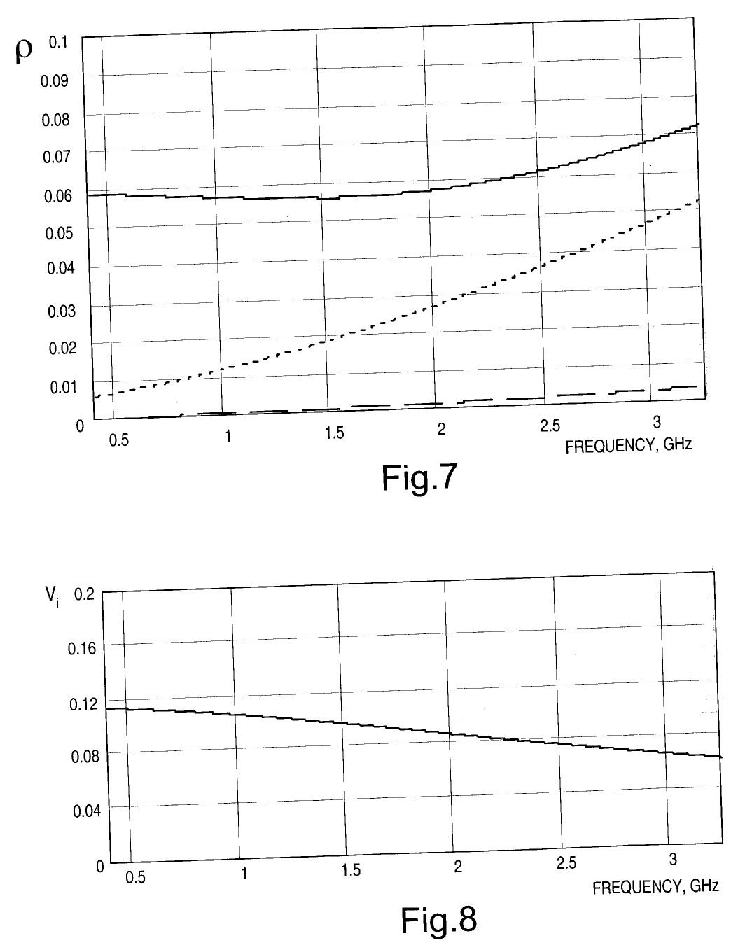

The effect of the termination incorporating the present invention is to reduce the size of reflections into the transmission line, hence increasing the signal to noise ratio at high frequencies. The efficiency in which the present invention achieves this is apparent from FIGS. 4 to 8, which show noise energies from reflections that are dramatically lower than would be the case using contemporary solutions to the termination problem and those in the prior art.

[image]

[image]

[image]

[image]

[image]

We claim:

1. A distributed terminator for terminating a transmission line having its end linked to an integrated circuit, the terminator comprising a parallel-connected resistor means connected in parallel to said integrated circuit and a series resistor means connected in series to the transmission line and said integrated circuit.

2. A distributed terminator according to claim 1 $wherein the overall resistance value of said parallel-connected resistor means and series resistor means differs from the transmission line impedance by 20% or less.

3. A distributed terminator according to claim 1, wherein the transmission line is linked to the integrated circuit via a driver incorporated therein, while the resistance value of said parallel-connected resistor means is 5-95% less than the impedance of the transmission line, depending on the capacitance of said driver.

4. A distributed terminator according to claim 1 wherein the transmission line is linked to the integrated circuit via a receiver incorporated therein, while the resistance value of said parallel-connected resistor means is 5-95% less than the impedance of the transmission line, depending on the capacitance of said receiver.

5. A distributed terminator according to claim 1, wherein the integrated circuit has a package connected thereto,.

6. A distributed terminator according to claim 1, wherein the and the series resistor means is arranged outside the package.

7. A distributed terminator according to claim 1, wherein the series resistor means forms a part of the package

8. A distributed terminator according to claim 5, wherein the parallel-connected resistor means is arranged within the integrated circuit.

9. A distributed terminator according to claim 5, wherein the parallel-connected resistor means is arranged within the integrated circuit package.

10. A distributed terminator according to claim 1, wherein the parallel-connected resistor means includes a plurality of resistors connected in parallel to said integrated circuit.

11. A distributed terminator according to claim 1, wherein the series resistor means includes a plurality of resistors connected in series to the transmission line and said integrated circuit.

12. A distributed terminator according to claim 11, wherein said plurality of resistors connected in series include package components as resistors.

13. A terminator according to claim 1, wherein the parallel-connected resistor means is connected to a terminating voltage within the integrated circuit.

14. A terminator according to claim 10, further including an inductor connected in series at least to one resistor of the parallel-connected resistor means.

15. A terminator according to claim 5, wherein the resistance value of said parallel-connected resistor means is determined with consideration for the capacitance of the package.

16. A data communication apparatus comprising a transmission line connected to an integrated circuit via a driver incorporated therein, where the transmission line is terminated by a terminator comprising a parallel-connected resistor means connected in parallel to said driver and a series resistor means connected in series to the transmission line and said driver.

17. A data communication apparatus comprising a transmission line connected to an integrated circuit via a receiver incorporated therein, where the transmission line is terminated by a terminator comprising a parallel-connected resistor means connected in parallel to said receiver and a series resistor means connected in series to the transmission line and said receiver.

18. A data communication system comprising a first integrated circuit, a second integrated circuit and a transmission line linking the first integrated circuit to the second integrated circuit, wherein the transmission line is terminated by a distributed termination according to claim 1.

19. A method of terminating a transmission line having its end connected to an integrated circuit, the method including the following steps:
determining the impedance of the transmission line;
determining the capacitance of ESD structure of said transmission line connection;
selecting desired frequency interval;
calculating the value of a parallel-connected resistor means and a series resistor means as a function of the impedance of the transmission line, capacitance of said ESD structure, and the selected frequency interval;
providing parallel-connected resistor means and series resistor means having the calculated values; and
connecting the parallel-connected resistor means in parallel to said integrated circuit, and connecting the series resistor means in series to the transmission line and said integrated circuit.
